(19) United States
(12) Patent Application Publication
(10) Pub. No.: US 2005/0209925 A1
(43) Pub. Date: Sep. 22, 2005

(54) Operation display method for POS system

(75) Inventor: Masakazu Ito, Kanagawa (JP)

Correspondence Address: FOLEY AND LARDNER;SUITE 500, 3000 K STREET NW, WASHINGTON, DC, 20007, US

(73) Assignee: NEC Infrontia Corporation

(21) Appl. No.: 11/063,729

(22) Filed: Feb. 24, 2005

(30) Foreign Application Priority Data
Feb. 26, 2003 (JP) 2003-048905

(51) Int. Cl. G06F 17/60

(52) U.S. Cl. 705/16

(57) ABSTRACT

An initial display view on display at log-in time is set up on the basis of the work kind, which is in-charge-person for operating a terminal is in charge of, the authority level bestowed to the in-charge-person and work start/end time data of work start and end times. More specifically, assigning operable work kinds are assigned based on authority levels representing degrees of responsibility, the operable work kinds are assigned based on the authority levels, and ID and authority level are given to each in-charge-person and registered together with the work start/end time data in an in-charge-person data. The authority level corresponding to a selected work kind is obtained after log-in by ID input by the in-charge-person and a work view of a predetermined one of work kinds assigned to the in-charge-person at the obtained authority level are determined on the basis of the in-charge-person master and the work start/end time data and displayed.

The present invention relates to working view display system for POS system, for instance, a working view display system for POS system for displaying key tops adopted to POS terminal operators.

### BACKGROUND OF INVENTION

The POS system is used in various shops such as superstores and fast food shops. The system permits obtaining various data such as sales data as real-time data, and it is thus important in view of the sales tactics as well. The operators of such POS system terminals are usually a variety of persons including tentative employees and part timers for executing sales processes. Also, the POS system executes not only the goods sales processes but also such management processes as work start/end management and processes of work kind, wages such as payment by the hour and other items. The system utilization status varies depending on the operators.

By way of example, various processes are involved as system utilization status. In the work start/end management process, the work start and end times of workers are managed. As processes executed in the shop are, for instance, sales process executed by tentative employees and part timers and account process (such as cancellation and correction of money amounts) executed by managers as responsible persons of shops.

In the meantime, for the operation of the terminal by setting up the duty service mode of the POS system at the time of opening the shop, operation is allowed in advance, and a registered operator does log-in in the terminal. After the log-in, the terminal operation is started by inputting predetermined ID. A view corresponding to a work assigned to an operator is displayed on a display by ID input by the operator. For example, with an operator who is a tentative employ having inputted the ID and in charge of an order process only, a sales view for executing the order process is displayed as display view after the ID input. The display view on the display is various, such as views of account process (e.g., cancel and correction of money amounts) and personnel management view as well as the sales view.

As shown, in the prior art POS terminal, a view is set up by the log-in by the operator. The set-up view is a predetermined view such as a sales view and a management view corresponding to the operator. The view is fixed by the operator in correspondence thereto. Usually, the order reception process function is the sole terminal function capable of being fulfilled by the tentative employee operator, and a sales view for this order process is displayed. As for the log-in view provided by a manager or a shop chief, a management view is fixedly displayed.

As described above, in the prior art working view display system for POS system, as a view to be displayed on the display at the log-in time of the POS system terminal, the work kind preliminarily registered for the operator is displayed by ID input by the operator. This display view is fixedly displayed, and usually it cannot be updated. For the updating, it is necessary to update the registration with the management function of the POS system terminal. More specifically, whenever the displayed (setting) view is to be changed by a manager as POS system manager, the setting has to be fulfilled with a master setting function process, which can be fulfilled only by an operator having a specific authority such as manager. That is, a complicated process has to be executed.

Furthermore, there is a work status in a shop, in which a person in charge of a plurality of different works, e.g., a register work in the morning and a dish carrier in the afternoon is employed. In such case, in the prior art work view display system for POS system, at the operation start time of the POS terminal with ID input a sales view showing an order process function as register work is displayed. Therefore, the display has to be changed to the dish carrier with the master setting function, which dictates a more complicated work.

### SUMMARY OF INVENTION

An object of the present invention is to provide a work view display system for POS system, in which the display view at the time of the set-up with log-in of the POS system terminal is set up and displayed as a view corresponding to the kind of work to be done by an in-charge-person from the consideration of the authority level given to the person in charge.

According to an embodiment of the present invention, there is provided a work view display system for POS system wherein an initial display view on display at log-in time is set up on the basis of the work kind, which is in-charge-person for operating a terminal is in charge of, the authority level bestowed to the in-charge-person and work start/end time data of work start and end times.

According to another embodiment of the present invention, there is provided a work view display method for POS system for displaying a work view corresponding to each predetermined work kind on a terminal display on the POS system, comprising the steps of: assigning operable work kinds based on authority levels representing degrees of responsibility; assigning the operable work kinds based on the authority levels, ID and authority level being given to each in-charge-person and registered together with the work start/end time data in an in-charge-person data; obtaining the authority level corresponding to a selected work kind after log-in by ID input by the in-charge-person; and determining and displaying a work view of a predetermined one of work kinds assigned to the in-charge-person at the obtained authority level on the basis of the in-charge-person master and the work start/end time data.

The in-charge-person becomes in charge of a changed work kind from the previous one, the work end time process is once executed before execution of the work start time process afresh. When the work start/end time data indicates that the in-charge-person is in work, a work view of a work kind selected at the log-in time is displayed. When the work start/end time data indicates that the in-charge-person is not in work, the authority level of the in-charge-person is obtained with reference to the in-charge-person data, and a work view of a predetermined one of the work kinds assigned to the in-charge-person is determined and displayed at the authority level of the in-charge-person. A predetermined operation shown in the work view is prohibited based on the authority level. The work view display system has an authority mask as aggregate of process units for setting up whether operation is able.

Other objects and feature of the present invention will be clarified from the following description with reference to the attached drawings.

### BRIEF DESCRIPTION OF DRAWINGS

FIG. 1 is a flow chart illustrating the process routine from log-in to view display in an embodiment of the working view display system for POS system according to the present invention;

FIG. 2 is a view showing an input part at the log-in time in the embodiment of the present invention;

FIG. 3 is a view showing a in-charge-person master in the embodiment of the present invention;

FIGS. 4(A) to 4(B) are views for describing the operation at the time of start time registration in the embodiment of the present invention;

FIG. 5 is a view for describing how working kind master authority level is obtained in the embodiment of the present invention;

FIG. 6 is a view for describing how display view based on the authority level is obtained in the embodiment of thee invention;

FIG. 7 is a view showing an example of display in the embodiment of the present invention;

FIG. 8 is a view showing an example of display view at the time of presence of work start data in the embodiment of he invention;

FIG. 9 is a view showing an example of display view at the time of absence of work start data in the embodiment of the present invention;

FIG. 10 is a view showing an example of display view at the time of presence of manager's work start time data in the embodiment of the present invention;

FIG. 11 is a view showing an example of authority master in a different embodiment of the present invention; and

FIGS. 12(A) and 12(B) are views showing a specific example of the embodiment shown in FIG. 11.

### PREFERRED EMBODIMENTS OF INVENTION

Now, a preferred embodiment of the a work view display system for POS system according to the present invention will be described in detail with reference to the accompanying drawings.

In this embodiment, an adequate display view at the log-in time is set up on the basis of the kind of work (such as register operator, dish carrier, cook and master setting manager), which a terminal operator such as employee or manager in a shop such as restaurant is in charge of, and authority level given to the each of operators. At this time, an adequate log-in view is displayed with reference to the work start/end time management of the work start and end times.

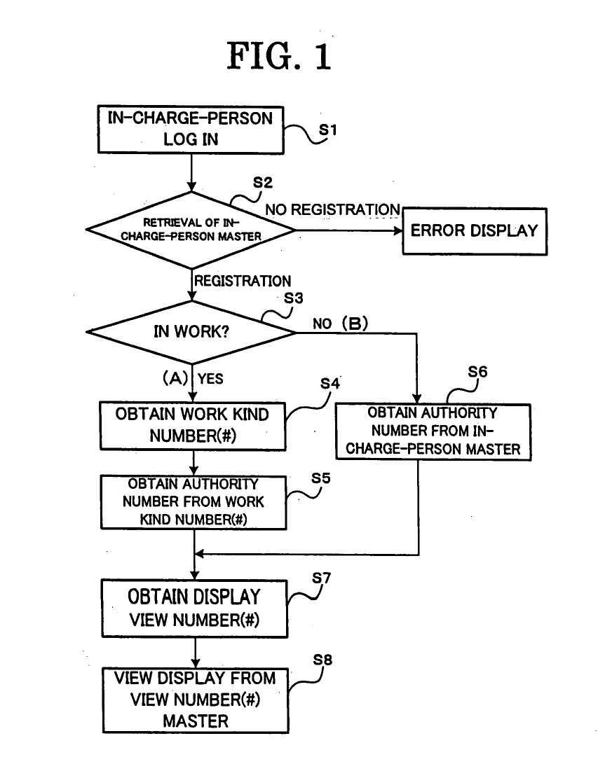

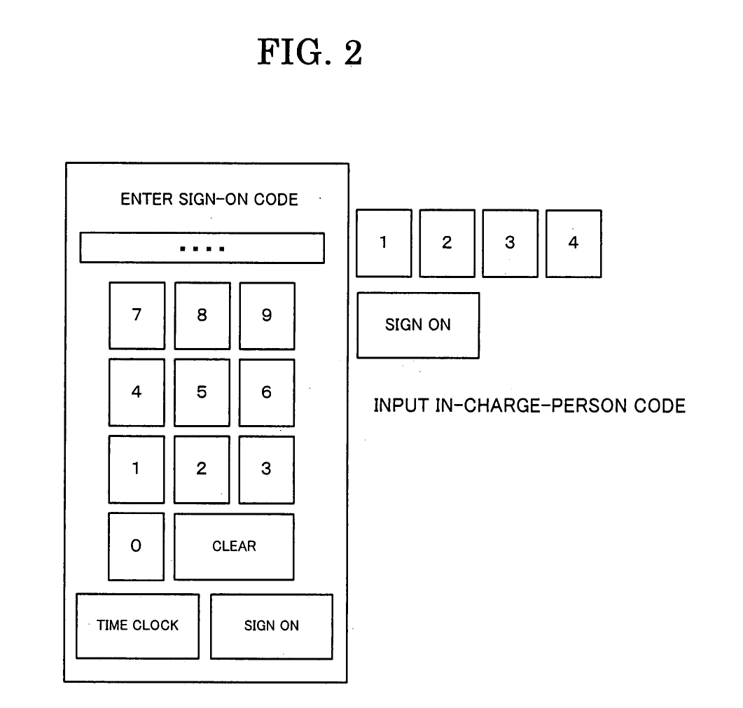

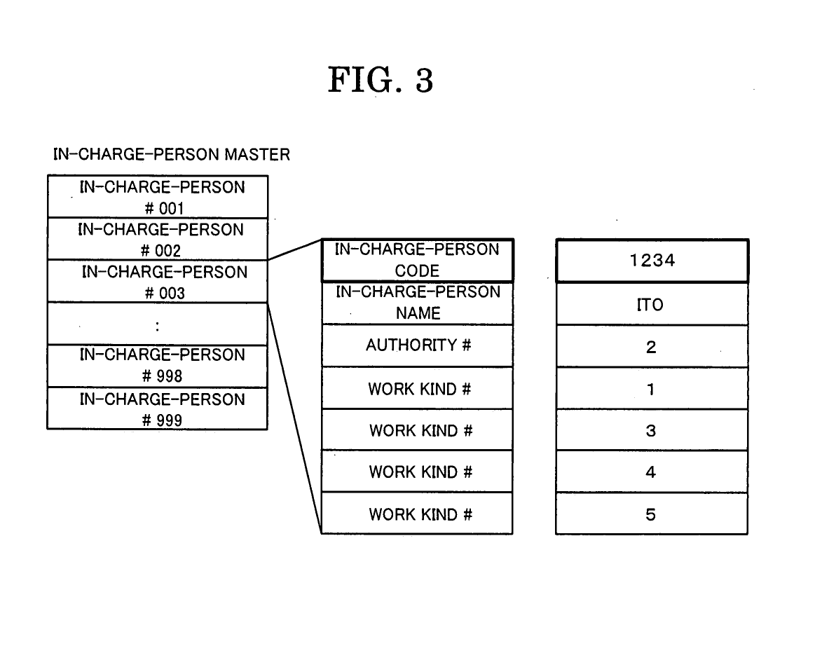

FIG. 1 is a flow chart showing the process routine in this embodiment. When an operator inputs an in-charge-person code (i.e., “1234” in this example) from an input unit (i.e., separately provided ten key set or display touch keys) of a terminal as shown in FIG. 2, the code is logged in (step S1), and in-charge-person master retrieval is executed (step S2). The retrieval is executed with reference to an in-charge-person master. As shown in FIG. 3, the in-charge-person master has prescribed stored data for each of the in-charge persons, i.e., an in-charge-person code, an in-charge-person name, an authority number (shown as AUTHORITY # in the Figure) and in-charge-person number (shown as IN-CHARGE-PERSON # in the Figure).

In the in-charge-person master shown in FIG. 3, for in-charge-person named Itoh, the in-charge-person code is “1234”, the authority number is “2”, and the assigned work kind number “1, 3, 4, 5”. In the step S2, a retrieval is made as to whether registration of the in-charge-person code of “1, 3, 4, 5” inputted by the in-charge-person is present. When no registration is found, an error display is made. When the registration is found, a check as to whether the in-charge-person has already in work (i.e., is in work) is made according to efficiency rating data (step S3). In this example, the in-charge-person code is present in the in-charge-person master, and it is thus determined that the in-charge-person is already in work.

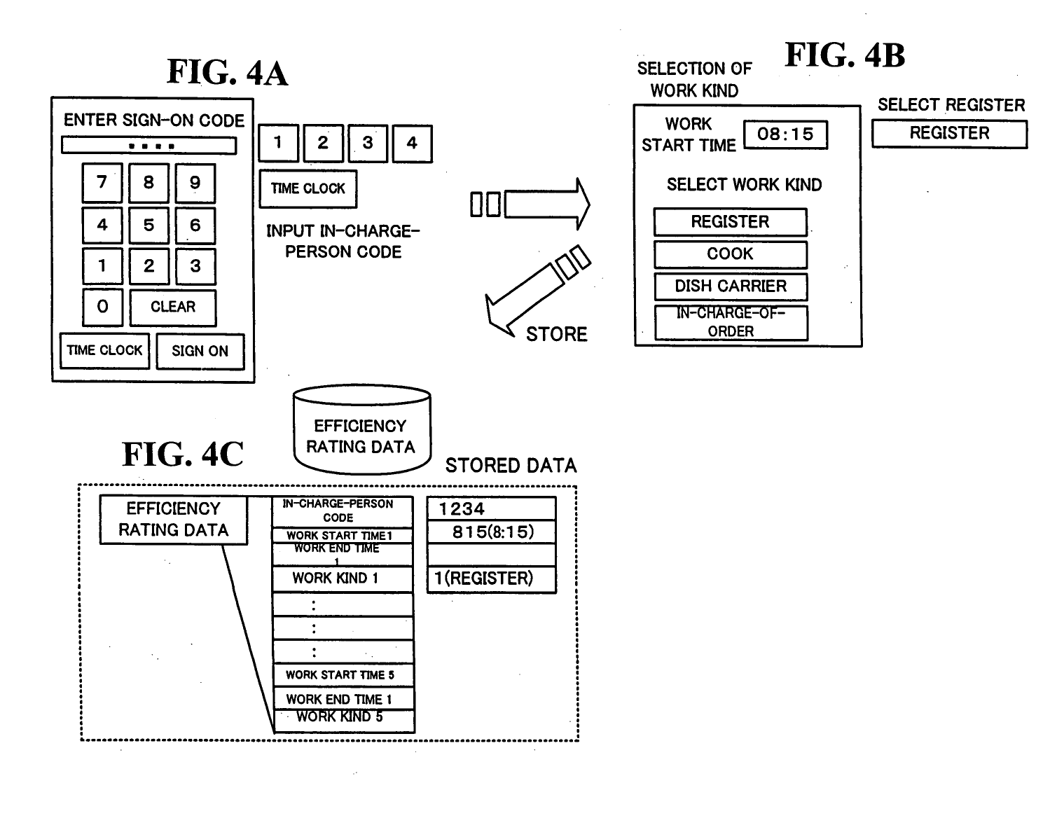

The efficiency rating data is produced in the following manner. As shown in FIG. 4(A), with the input of the in-charge-person from an input unit like that shown in FIG. 2, the time data at the input time is obtained from a clock part (TIME CLOCK). Thus, the work kind (i.e., either register operator, cook, dish carrier, in-charge-of-order, etc. in this example) assigned to the pertinent in-charge-person is displayed together with the work start time data on the display. Then, as shown in FIG. 4(B), the in-charge-person selects the kind of work in charge of him or her (i.e., selects the “register operator” in this example) from the display view. Such data is stored as efficiency rating data in the memory. As the efficiency rating data, the work start time, the work end time and the work kind number constitute a set for each in-charge person. Each set is registered for each work kind. For changing the work kind, the work start/end time process is once executed, and then the work start time process is executed again to select the work kind. Numbers “1”, . . . , “5” are assigned to work kinds, respectively. The repeated work start time, work end time and work kind data are necessary in the case where, for instance, different work kinds are in charge in the morning and the afternoon. This is so because the payment by the hour varies with the work kind. This arrangement facilitates the salary calculation.

As described above, the decision in the step S3 as to whether the in-charge-person is in work, is made by making retrieval, on the basis of the inputted in-charge-person code, as to whether work start time data of the came code is present in the efficiency rating data area. The decision can also be made on the basis of such data as including work start time and work kind data and without registration (i.e., no data) of the work end time. When it is decided in the step S3 that the in-charge person is in the work, in this example a work kind number (i.e., “1” in this example) is obtained on the basis of the in-charge-person code, the work start time 1 (i.e., 8:15), work end time 1 (i.e., no data) and work kind 1 (register operator), these data being included in the efficiency rating data (step S4), and the authority number of the work kind master is obtained from the obtained work kind number (step S5).

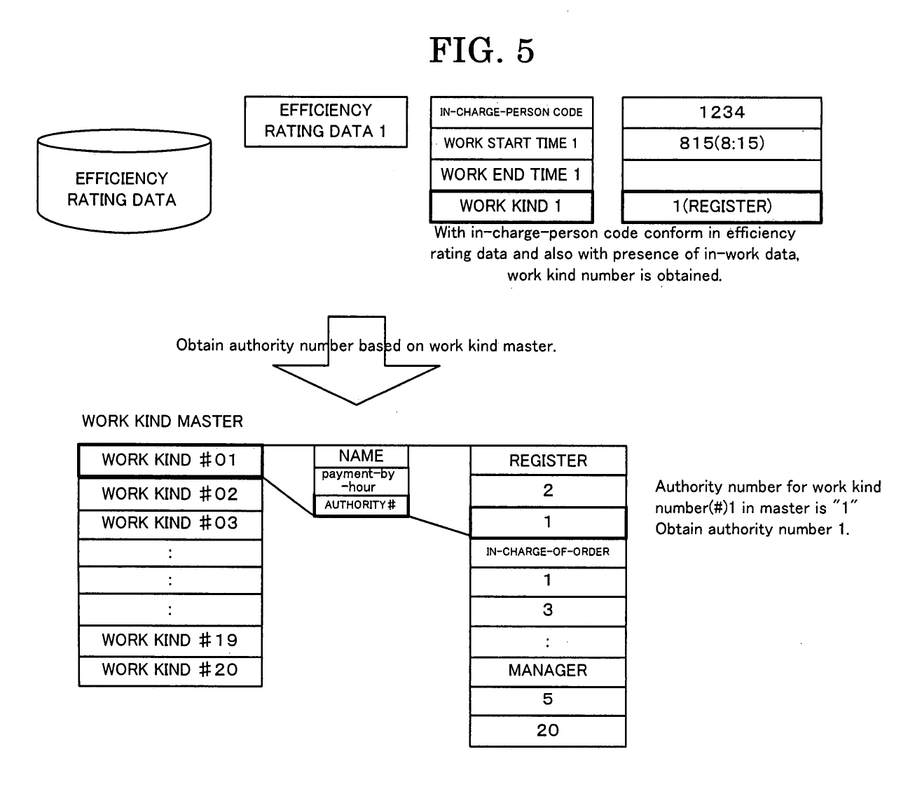

The work kind number and the authority number are obtained as shown in FIG. 5. With in-charge-person code of “1234” conforming in the efficiency rating data and also with the presence of the data of the in-work (i.e., 8:15), the work kind number (i.e., “1”: register operator in this example) is obtained. In the work kind master are stored, for each work kind number, name (i.e., “register operator”, “order reception personnel”, . . . , “manager”, payment-by-hour number (shown as PAYMENT-BY-HOUR NUMBER # in the Figure) (i.e., “2”, “1”, . . . , “5”), and authority number (“1”, “3”, . . . , “20”). The authority number is obtained on the basis of the work kind master.

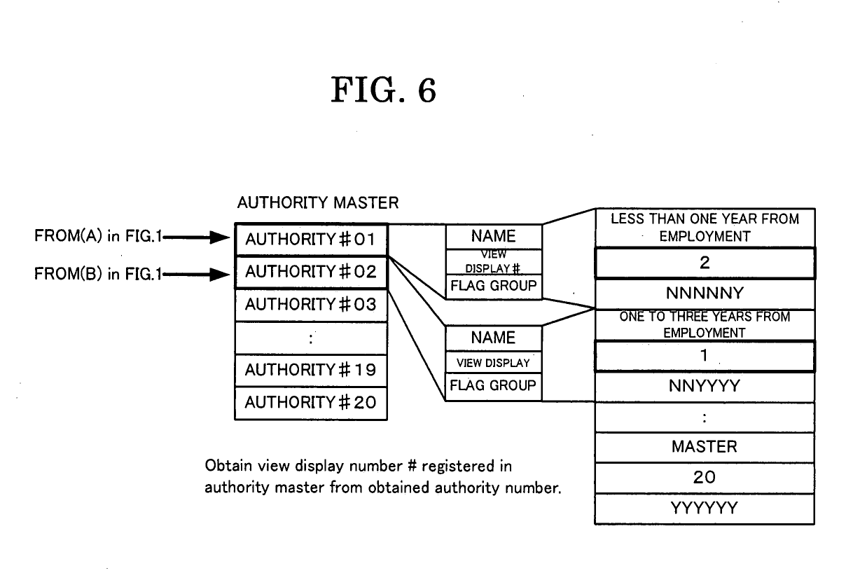

Subsequently, in the step S7 display view number (shown as VIEW # in the Figure) is obtained. More specifically, as shown in FIG. 6, display view number of “2” (register operator) is obtained in a process subsequent to the process in the step S2 on the basis of the authority master authority number of “1” (number of employees of less than one year from the employment, and is set as the display view. The flag group in FIG. 6 will be described later. Meanwhile, subsequent to the step S5, display view number of “1” (order reception personnel) is set on the basis of the authority number of “2” (one to three years from the employment). View display from the view number master is thus made on the basis of the view number thus obtained (step S8).

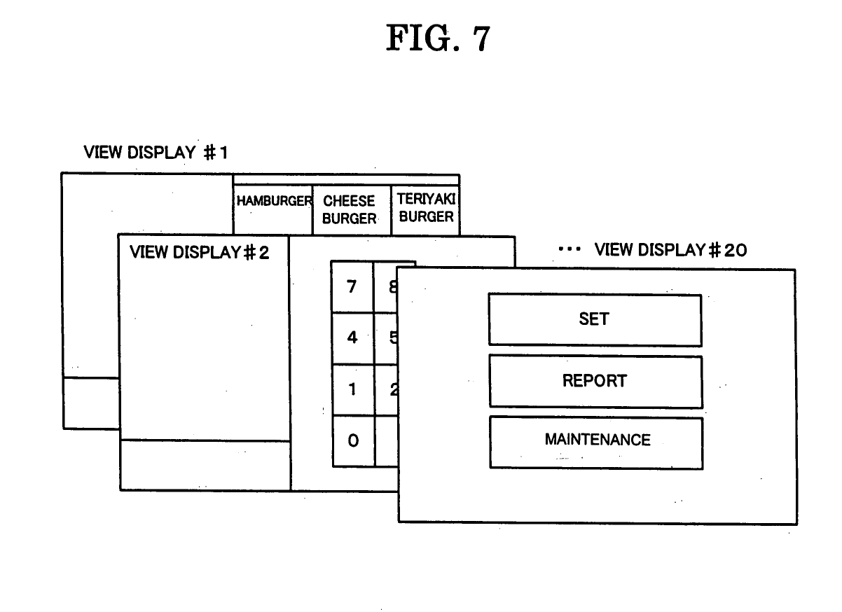

FIG. 7 shows the view number of “1” (order reception personnel), “2” (register operator) and “20” (master setting) More specifically, the display view number of “1” represents a sales view for the order reception personnel, the display view number of “2” represents a view for the register operator, and the display view number of “20” represents a view for master setting (i.e., setting, report and maintenance) made by manager.

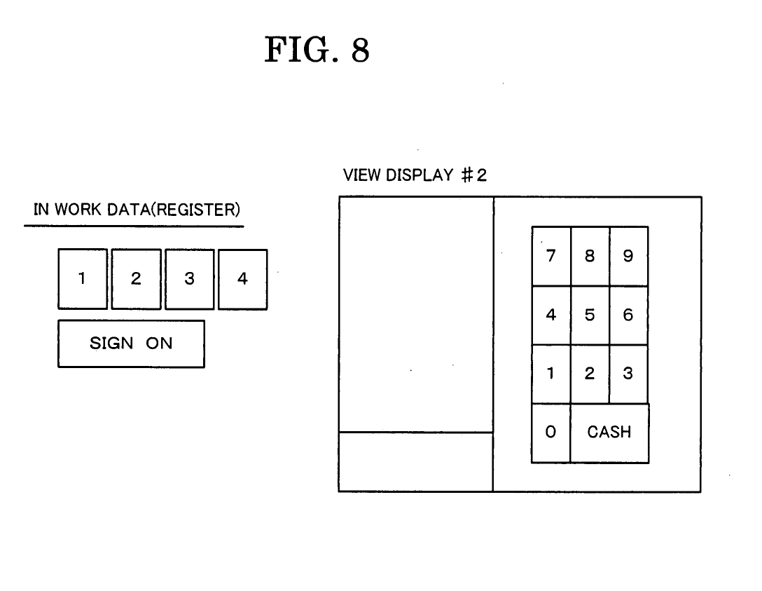

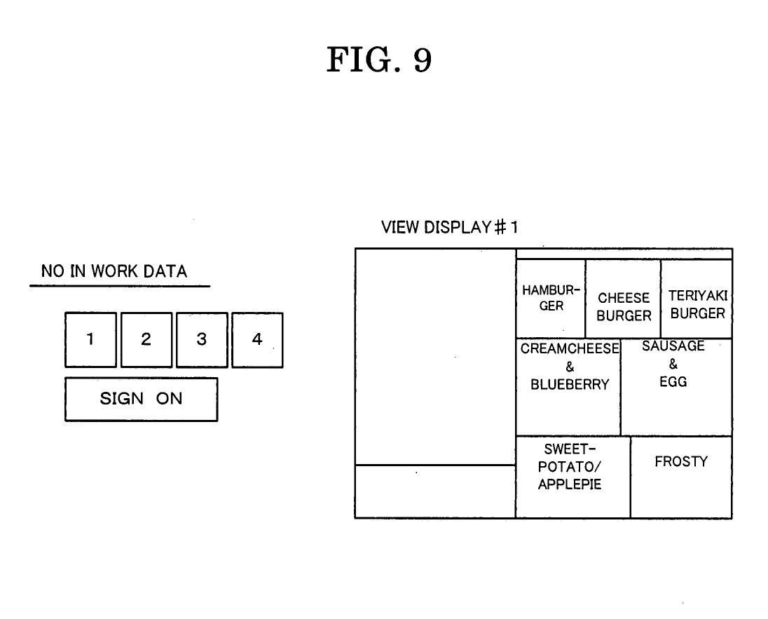

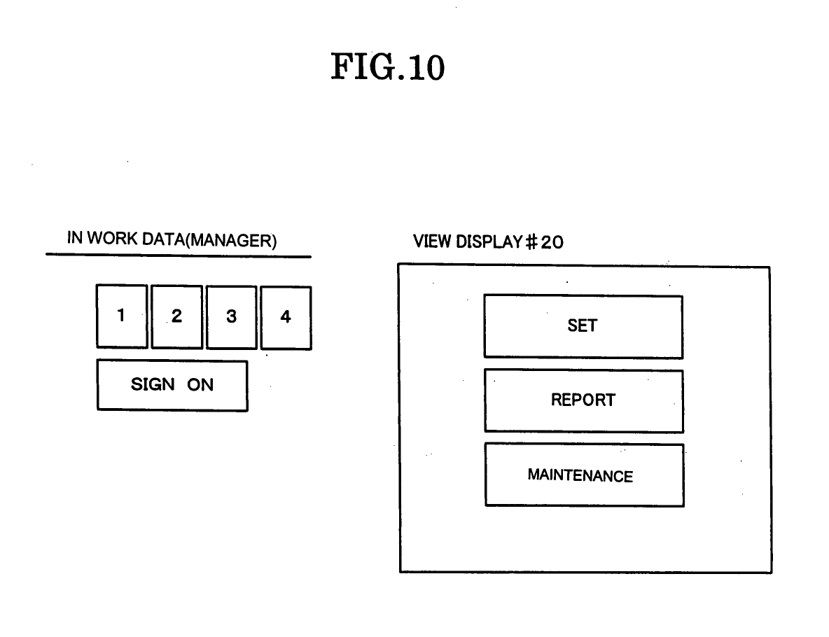

Specific examples will now be described. FIG. 8 shows work start time data. The data is of the case with register operator set as work kind. As shown, with the input of the in-charge-person code of “1234”, a view for the register operator with view number of “2” is finally displayed. FIG. 9 shows the data in the no work start time data case. With the input of the in-charge-person doe of “1234”, a sales view for the order reception personnel with view number of “1” is finally displayed. FIG. 10 shows the work start data in the case of presence of the work start time data. In this case, a view is finally displayed by the input of the in-charge-person data by a manager having a high authority level. As noted above, the work kind number of “20” (master setting), the authority number of “20” and the display view number of “20” are displayed are displayed in the mentioned order.

When it is decided in the step S3 that the in-charge-person is not in work, a step S6 is executed, in which authority number of “2” is obtained because in the in-charge-person master as shown in FIG. 3 the authority number of in-charger-person number (shown as IN-CHRGE-PERSON # in the Figure) of 003 of he in-charge-person master having in-charge-person code of “1234” is “2”. The routine then goes to the process in the step S7.

In the above embodiment, a view number can be assigned to each of what is thought to be works in a shop, in which an in-charge-person does a plurality of different kinds of works. The view number can be provided fir each work. Thus, it is possible to display a view conforming to each work at all times. (In this embodiment, it is possible to display at most four views as the number of different kinds of works assigned to one in-charge-person.)

In a different embodiment of the present invention, the authority master content of the in-charge-person presently in log-in and view display data content are compared at the instant of displaying the view. Then, when a key which is an unable key at the authority level to which the in-charge-person belongs is present, such key is not displayed or made to be inoperative even in the presence of view data at the instant of displaying the view.

This corresponds to making a key, which is among the keys disposed in the view and can not be handled (i.e., results in error when operated), in combination with the authority level belonged to by the in-charge-person presently in log-in, to be out of display or incapable of being operated. In other works, when a cancel key is an unable key at the authority level at the time of displaying the view, it is not displayed. By so doing, the keys which cannot be handled by the in-charge-person are not displayed in the view, and thus erroneous operation of the in-charge-persons is eliminated.

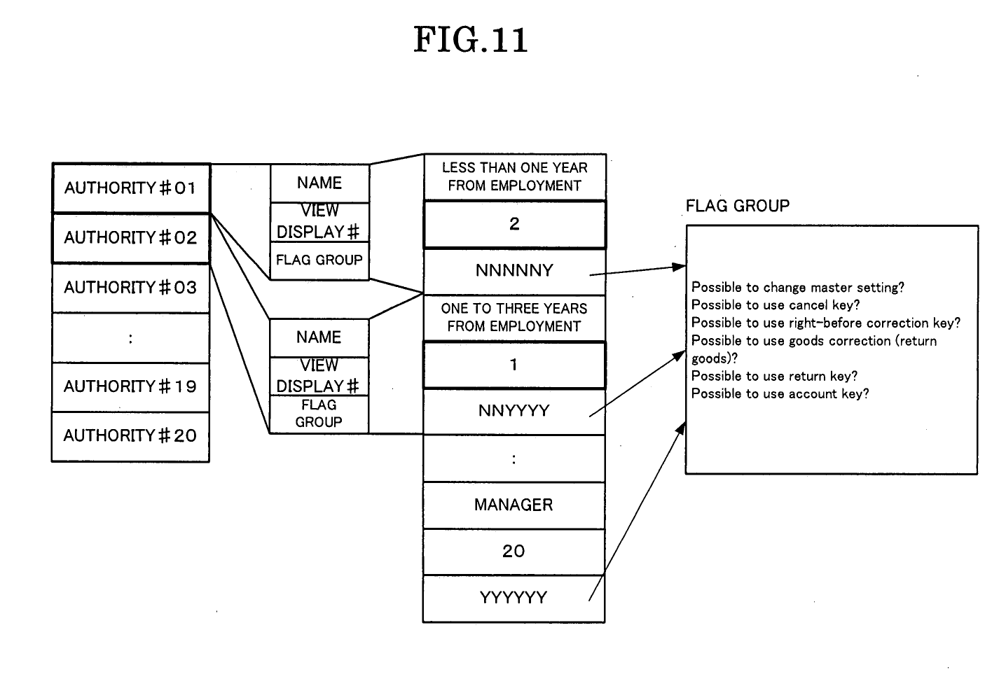

FIG. 11 shows an example of authority master necessary for this embodiment. This authority master is like that shown in FIG. 6. The flag group is for setting process group items necessary in such personnel and account processes of “Is it possible to change master setting ?”, “Is it possible to use cancel key ?”, “Is it possible to use right-before correction key ?”, “Is it possible to use goods correction (return goods) key ?”, “Is it possible to use account key ?”. For example, employees of less than one year from the employment are not allowed to handle other keys than the account key. Also, employees of one to three years from the employment can handle keys other than the master setting change and cancel keys. Furthermore, managers can operate all the keys. In this way, persons of high authority level (i.e., heavy responsibility) can execute processes of higher importance, and persons without responsibility are given greater restriction on the keys that can be used.

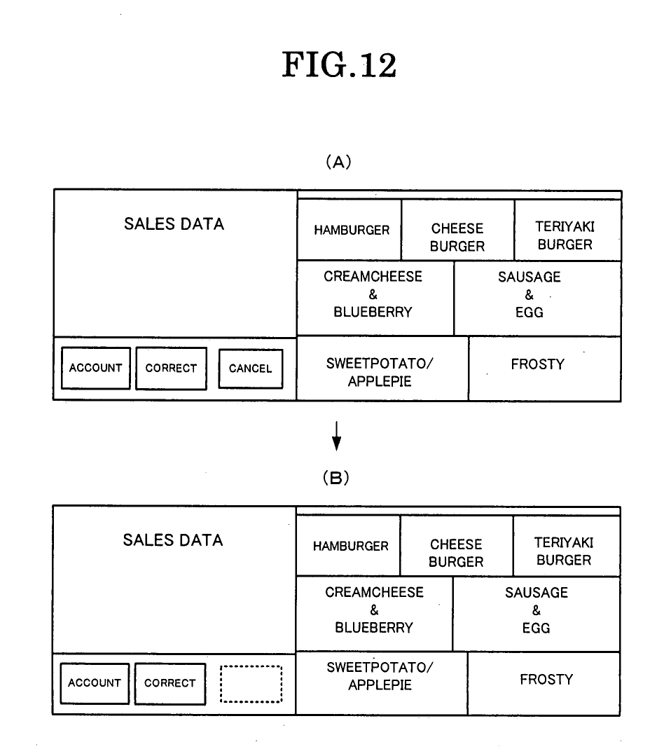

Referring to FIGS. 12(A) and 12(B), FIG. 12(A) shows an order/sales view which can be used by the manager. In this case, the account, correction and cancel keys are all displayed because they are handled by high authority level managers. However, in the case of handling by low authority level in-charge persons, the cancel key is not displayed. With this arrangement, it is possible to prevent illegality of the employees.

As has been described in the foregoing, in the work view display system for POS system according to the present invention, as the display view at the operation start time of raising by the log-in of the POS system terminal, it is possible to set an adequate display view of works to be executed by the operator with consideration of the authority level bestowed to the operator. Thus, not only quick process is possible, but also it is possible to reliably carry out personnel management such as salary calculations.

More specifically, even in a shop in which an in-charge-persons does a plurality of works, since a work view can be provided for each work kind, it is possible to display a view fitted to the work of the in-charge-person. Also, since keys unable to be handled by in-charge-persons are not displayed on the view, erroneous operation (i.e., unnecessary error generation) by the in-charge person can be eliminated.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

1. A work view display system for POS system wherein an initial display view on display at log-in time is set up on the basis of the work kind, which is in-charge-person for operating a terminal is in charge of, the authority level bestowed to the in-charge-person and work start/end time data of work start and end times.

2. A work view display method for POS system for displaying a work view corresponding to each predetermined work kind on a terminal display on the POS system, comprising the steps of:
assigning operable work kinds based on authority levels representing degrees of responsibility;
assigning the operable work kinds based on the authority levels, ID and authority level being given to each in-charge-person and registered together with the work start/end time data in an in-charge-person data;
obtaining the authority level corresponding to a selected work kind after log-in by ID input by the in-charge-person; and
determining and displaying a work view of a predetermined one of work kinds assigned to the in-charge-person at the obtained authority level on the basis of the in-charge-person master and the work start/end time data.

3. A work view display system for POS system according to claim 1, wherein the in-charge-person becomes in charge of a changed work kind from the previous one, the work end time process is once executed before execution of the work start time process afresh.

4. A work view display system for POS system according to claim 1, wherein when the work start/end time data indicates that the in-charge-person is in work, a work view of a work kind selected at the log-in time is displayed.

5. A work view display system for POS system according to claim 1, wherein when the work start/end time data indicates that the in-charge-person is not in work, the authority level of the in-charge-person is obtained with reference to the in-charge-person data, and a work view of a predetermined one of the work kinds assigned to the in-charge-person is determined and displayed at the authority level of the in-charge-person.

6. A work view display system for POS system according to claim 1, wherein a predetermined operation shown in the work view is prohibited based on the authority level.

7. A work view display system according to claim 6, which has an authority mask as aggregate of process units for setting up whether operation is able.
